(19) United States
(12) Patent Application Publication
(10) Pub. No.: US 2024/0378532 A1
(43) Pub. Date: Nov. 14, 2024

(54) SYSTEMS AND METHODS FOR A SMALL BUSINESS CONTINUITY PLANNER

(71) Applicant: WELLS FARGO BANK, N.A., San Francisco, CA (US)

(72) Inventors: Sadie S. Salim, Mill Valley, CA (US); Rajeswaran Govindan, Livermore, CA (US); Dennis E. Montenegro, Concord, CA (US)

(21) Appl. No.: 17/812,101

(22) Filed: Jul. 12, 2022

(51) Int. Cl. G06Q 10/06

(52) U.S. Cl. CPC G06Q 10/0635

(57) ABSTRACT

Systems and methods for assisting small businesses to plan for and fix interruptions in business using machine learning and artificial intelligence are disclosed. One disclosed system includes a processor and memory with stored instructions which when executed by the processor cause the processor to receive current local data associated with a business; receive current external data associated with the business; categorize or classify the current local data and current external data into a category; access a database of prior local data and prior external data in the same category; and determine, based on machine learning and the current local data, current external data, prior local data, and prior external data, an action to reduce the risk of interruption of the business.

### FIELD OF INVENTION

The present disclosure generally relates to artificial intelligence and machine learning, and more particularly to systems and methods for using artificial intelligence and machine learning to plan for interruptions in business.

### BACKGROUND

Small businesses are often at a competitive disadvantage to larger businesses because of an asymmetry in information regarding how to effectively run a business in the event of a crisis or disruption that interrupts business. Larger businesses may employ teams of analysts who monitor world events and recommend actions the business should take to prevent or rectify interruptions to business. Small businesses on the other hand often lack the resources, infrastructure, and technical knowledge to prepare themselves for interruptions in business. Thus, there is a need for a system that assists small business owners in planning for interruptions to business.

### SUMMARY

According to certain embodiments, a method for a small business continuity planner may comprise receiving current local data associated with a business; receiving current external data associated with the business; categorizing or classifying the current local data and current external data into a category; accessing a database of prior local data and prior external data in the same category; determining, based on machine learning and the current local data, current external data, prior local data, and prior external data, an action to reduce the risk of interruption of the business.

According to another embodiment, a non-transitory computer readable medium may comprise program code, which when executed by one or more processers, causes the one or more processors to: receive current local data associated with a business; receive current external data associated with the business; categorize or classify the current local data and current external data into a category; access a database of prior local data and prior external data in the same category; determine, based on machine learning and the current local data, current external data, prior local data, and prior external data, an action to reduce the risk of interruption of the business.

According to another embodiment, a system for a small business continuity planner may comprise: one or more processors; and a memory that stores instructions that, when, executed by the one or more processors, cause the one or more processors to: receive current local data associated with a business; receive current external data associated with the business; categorize or classify the current local data and current external data into a category; access a database of prior local data and prior external data in the same category; determine, based on machine learning and the current local data, current external data, prior local data, and prior external data, an action to reduce the risk of interruption of the business.

This illustrative example is mentioned not to limit or define the limits of the present subject matter, but to provide an example to aid understanding thereof. Illustrative examples are discussed in the Detailed Description, and further description is provided there. Advantages offered by various examples may be further understood by examining this specification and/or by practicing one or more examples of the claimed subject matter.

### BRIEF DESCRIPTION OF THE DRAWINGS

A full and enabling disclosure is set forth more particularly in the remainder of the specification. The specification makes reference to the following appended figures.

FIG. 1 shows an illustrative example of a small business continuity planner communicating to multiple devices and data sources.

FIG. 2 illustrates a flow chart for a method for operating a small business continuity planner, particularly illustrating how a small business continuity planner system may determine actions a business should take based on received local and external data.

FIG. 3 illustrates a flow chart for a method for operating a small business continuity planner, particularly illustrating how a user graduates the small business continuity planner between levels of authority.

FIG. 4 illustrates a flow chart demonstrating the use of data and feedback from past recommendations received by the small business continuity planner in determining future recommendations.

FIG. 5 shows an illustrative example of a small business continuity planner that shares information with and learn from other small business continuity planners using a shared database.

### DETAILED DESCRIPTION

Reference will now be made in detail to various and alternative illustrative examples and to the accompanying drawings. Each example is provided by way of explanation, and not as a limitation. It will be apparent to those skilled in the art that modifications and variations can be made. For instance, features illustrated or described as part of one example may be used on another example to yield a still further example. Thus, it is intended that this disclosure include modifications and variations as come within the scope of the appended claims and their equivalents.

### Illustrative Embodiment of a Small Business Continuity Planner

In one illustrative embodiment a small business continuity planner comprises an application executed on a computer system for generating recommendations to small business owners to prevent disruptions from interrupting business. The application receives data from small business owners associated with the business. For example, the application receives information such as the location of the business, information related to the employees, and other information such as the business's hours, expenses, and other relevant business information. The application includes templates for different types of business, which prompts the small business owner to enter information related to the chosen template. For example, a small business owner of a restaurant is prompted under a restaurant template to enter information such as a menu with commonly used ingredients, shelf dates of ingredients, and other information important for running a restaurant.

The application also receives data from sources other than the small business owner such as from websites, databases, news sources, sensors located at or near the business, and social media feeds. The template is pre-configured to identify sources of data, and sources of data are added by the application. For the example of a restaurant, the application checks new sources for information related to inclement weather and natural disasters such as floods, hurricanes, and droughts that affect availability of ingredients, or social media for local events such as demonstrations that effect access to the restaurant.

The application uses the data received from the small business owner and other sources to anticipate and respond to disruptions by determining recommendations and taking action for the small business to prevent disruptions from interrupting business. The application takes actions such as notifying business owners and employees of ongoing or anticipated disruptions, and provides recommendations for the business owner to resolve the disruptions. The application also orders supplies for the business owner in anticipation of shortages or anticipated changes in price of the supplies.

The application is given different levels of authority to act by the small business owner. The small business owner provides feedback to the application initially, and the application uses the feedback to improve future recommendations. For example, when the application is being used by a restaurant, the application receives data indicating a shortage of cheddar cheese. The application recommends the restaurant owner substitute cheddar cheese with a more readily available cheese. However, the restaurant owner may disagree with the application's recommendation, and instead prefer to replace cheddar cheese with a cheese having shared characteristics such as a texture similar to cheddar cheese. Characteristics are shared when the characteristics match or when the characteristics are within a pre-determined tolerance of another characteristic. In the example of the replacement of cheese, different cheeses are assigned values by the restaurant owner or other data source which quantifies characteristics to allow for comparison of characteristics by the small business continuity planner. The application receiving the feedback implements the feedback in future shortages of cheese to provide future recommendations for replacements that share characteristics, such as texture.

When the small business owner determines that the application is providing recommendations that the small business owner agrees with, the small business owner graduates the application to have more autonomy. In the example of the restaurant, the restaurant owner may graduate the application to order replacement ingredients without requiring restaurant owner confirmation or order replacement agreements below a preset value without requiring restaurant owner confirmation.

### Example Embodiments of a Small Business Continuity Planner

One illustrative example of the present disclosure comprises an application executed on a computing system such as a computer, mobile phone, tablet, or other computing device. The small business continuity planner may be executed by the computing system as a native application or may comprise web-based application accessed using a web-browser.

The small business continuity planner may be configured to receive input data from one or more users, external sources such as databases, websites, social media feeds, news broadcasts, a provider of the application, and other applications of similar businesses.

The small business continuity planner receives data and determines actions to maintain business continuity. The actions comprise recommendations to the user, or comprise actions the system executes to ensure business is not interrupted. The actions may comprise: generating recommendations to order materials to protect the business from inclement weather; ordering products before the business sells out; notifying the small business owner and employees of inclement weather and traffic; coordinating substitute employees to take on sick employee's shifts; and other actions to help ensure the business is able to continue without interruption.

In one illustrative example, the small business continuity planner includes software that provides a template tailored for different types of small businesses, such as a template tailored for restaurants, a template tailored for grocery stores, and templates for other businesses. A small business owner enters current local data associated with the business. The data includes, for example, current inventory, current staffing levels, employee availability, employee wages, other employee information, business products, business services, historical sales data, geographic location of the business, and geographic location of competing businesses.

In other examples, the small business continuity planner is configured to integrate with software systems used by the small business to gather current local data associated with the business. For example, instead of a small business owner entering current local data associated with the business into a template regarding employee pay rates and hours, the small business continuity planner gathers data from accounting software used by the small business.

Based on the current local data associated with the business, the small business continuity planner identifies sources of current external data relevant to the business. The type of current external data and current local data identified by the small business continuity planner is classified based on the velocity of the data as either slower-moving data (SMD) or faster-moving data (FMD). SMD is data with relatively low velocity, such as industry-wide historical data that describes a typical restaurant in an urban area, data regarding nearby competitors, and other data. FMD is data with relatively high velocity, such that the data may change relatively often, such as current foot traffic in the area around the small business, current location of employees, latest news regarding traffic, weather, and other data.

In some embodiments, the small business continuity planner is configured to access data sources of information relevant to a specific type of business. For example, if the small business is a delivery business, the small business continuity planner is pre-configured to: monitor the price of gas from a website tracking gas prices, monitor traffic issues from a local news site, monitor a list of local Chambers of Commerce from which the small business continuity planner may extract statistics, and access other data sources. The small business continuity planner is also configured to access data from other applications and banking accounts used by the small business owner in the business. In one example, the small business continuity planner tracks the sale of items by the business in addition to inventory purchases through the small business's banking account and shipping data from delivery services to track inventory of the business.

The small business continuity planner is also configured to receive inputs from peripheral devices. For example, a business may store inventory on a scale, and the business may connect the scale to the small business continuity planner, which tracks the weight of the inventory. When the weight of the inventory reaches a user specified or pre-determined value, the small business continuity planner recommends ordering additional inventory. In alternative examples, the small business continuity planner measures the weight of the inventory over time, and determine from rates of usage of the inventory, historical sales data, or other data whether to recommend ordering additional inventory. In still other embodiments, an optical sensor (e.g., a camera such as security camera) may transmit image signals to the small business continuity planner to use to determine the quantity of inventory over time.

The small business continuity planner may also be connected to other peripherals such as security cameras or other sensors. The small business continuity planner uses security cameras to track foot traffic around the business or to identify an influx of customers to the business. The small business continuity planner makes recommendations based on the information, such as recommending requesting another employee come to work to accommodate the influx of customers. The small business continuity planner also identifies other information related to the influx of customers to anticipate future influxes of customers. For example, the small business continuity planner identifies that the influx of customers occurs whenever there is an event at a local restaurant. The application then monitors the local restaurant's website and schedules additional employees to work on nights where the local restaurant holds an event.

The small business continuity planner also receives inputs from other peripheral devices such as motion detectors, infrared sensors, LiDAR, and other sensors to track information associated with the business. For example, the small business continuity planner implemented in a restaurant may include a motion detector near a trash disposal area. When the motion detector is not triggered at a preset time before the employee's closing shift, the small business continuity planner identifies that trash generated by the restaurant has not been taken out prior to the restaurant closing and notify employees working the opening shift that the trash needs to be taken out.

The small business continuity planner sets up agents to monitor the SMD and FMD, and the agents are given authority by the user to update the template with new local and external data. The agents are configured to: establish and activate API calls; screen scrape information by extracting readable information from news sites or other websites; implementing Natural Language Processing (NLP) to extract information from websites through the websites' HTML code; process audio/visual sources; monitor emergency services; monitor weather services; and monitor other written, audio, and visual data sources.

Additional examples improve system resource usage by identifying where data changes periodically so as to determine when an agent should be active or dormant. For example, if the agent identifies a local news site as a source of FMD, and the agent identifies that the website rarely updates after 10 PM ET and before 5 AM ET the next day, the agent monitoring the local news site may remain dormant between 10 PM ET and 5 AM ET to conserve system resource usage.

The small business continuity planner identifies disruptions and determines likelihood that the disruptions will interrupt business based on received data. For example, the small business continuity planner for a bar receives information from a weather service indicating there is a parade planned to be held across town. The small business continuity planner identifies that business is likely interrupted when there is a parade on the street where the business is located, but because the parade is across town, the small business continuity planner determines that the disruption is unlikely to interrupt the business. However, where the protest is held closer to the business, the small business continuity planner determines that business is more likely to be interrupted. The small business continuity planner determines a risk value representing probability that business will be interrupted by the disruption. The amount of risk small business owners are willing to tolerate before allowing the small business continuity planner to execute an action is configurable by the small business owner. The small business owner may set a minimum risk value the small business continuity planner must reach before the small business continuity planner executes an action. The small business owner may also adjust the weight of data or data sources in determining the risk value. For example, the small business owner trusting a particular weather service values the particular weather service's opinion more than other data sources and adjusts weight given to the particular weather source in the determination of the risk value by the small business continuity planner.

In another example, the small business continuity planner receives data from a news website indicating that shipping issues is causing a shortage of an ingredient included in a dish in a restaurant. The small business continuity planner identifies the ingredient as being included by comparing the ingredient to the menu and list of ingredients by the small business owner for the restaurant. The small business continuity planner also, taking into account sales data indicating that the dish is popular in the restaurant, determines that disruptions to the ingredient will likely interrupt business because of the popularity of the dish, and recommends that the restaurant purchase more of the ingredient before the ingredient becomes unavailable, or recommends substituting the ingredient in the dish.

The small business continuity planner recommends long-term and short-term solutions based on data received from the user and gathered by the agents, the risk value, other underlying logic, and the disruption interrupting business. Short-term solutions are actions that the small business continuity planner executes or recommends to the user to solve an immediate interruption in business. For example, a bank teller calls out sick for work. The small business continuity planner identifies the employees who are off today and sends a notification to another teller requesting that the teller take on the shift of the sick bank teller. Other examples of short-term solutions may include but are not limited to the system: sending notifications, making recommendations, or interacting with external systems to produce a result. The short-term solutions recommended by the system may be intended to be stop-gap solutions until a more permanent solution may be determined.

Long-term solutions are actions that the small business continuity planner recommends to improve the small business's resilience in the future. Long-term solution also include solutions that may not be quickly implementable, but if implemented, would prevent disruptions in the future from interrupting business. For example, a restaurant having a minor leak in the roof may need to be closed during storms. A short-term solution such as a contacting a repairman to apply a temporary patch resolves the leak temporarily, however the long-term solution may be to contact a roofing company to buy a new roof. Long-term solutions also includes actions that prevent disruptions from occurring in the future. Examples of long-term solutions may include but are not limited to: scheduling periodic checkups on the small business, tracking of progress on projects to make sure the project is on target, or recommending hiring new staff.

The long-term and short-term solutions recommended by the small business continuity planner may include a rating associated with the solution. The rating may include severity ratings, which allows the small business continuity planner to rank solutions based on how drastic or severe of an action the solution may be. For example, sending an employee who is running late for work a notification about the employee's shift may be ranked as low severity, whereas contacting a temporary staffing agency for a new employee may be ranked as high severity. Severity ratings may also take into account the monetary cost of implementing the solution, among other factors.

The small business continuity planner may create an initial customized configuration with the current local and current external SMD and FMD, and other data gathered by the system and/or inputted by the user. The initial customized configuration is a baseline configuration for the user to validate. The system may prompt the user to validate or modify the baseline configuration.

The baseline configuration may be conveyed to the user in a graphical user interface accessible on the user's mobile device, browser, tablet, computer, or other computing device. The graphical user interface may include but is not limited to the user's inputted data and selections, determinations the system made from user selections, a list of FMD and SMD sources, and data gathered by the agents.

In some examples, the user may continue to add additional FMD or SMD sources which the small business continuity planner may use in future determinations.

In some embodiments, the small business continuity planner operates in three states. The three states are distinguished based on authority of the small business continuity planner to implement recommendations without requiring permission from the user to execute. As the user adjusts the small business continuity planner, and as the small business continuity planner provides more short-term and long-term solutions to interruptions in business that the user agrees with, the user may graduate the small business continuity planner to another state so as to allow execution of actions with less oversight from the user.

In the first state the small business continuity planner does not provides recommended long-term and short-term solutions, but does not implement them without user input. In an embodiment of the small business continuity planner in the first state, it may begin by displaying short-term and long-term solutions recommended by the small business continuity planner to resolve the interruption to business, but the small business continuity planner may not take steps to carry out the solutions.

The user may modify the solution recommended by the first state of the small business continuity planner, and the small business continuity planner may incorporate the feedback of the user into future recommendations. As the user provides more feedback, the small business continuity planner uses the feedback to generate recommendations more helpful for the user. When the user is satisfied with the recommendations, the user graduates the small business continuity planner to a second state with less user oversight than the first state.

The small business continuity planner generates recommendations that incorporate feedback from the user into future feedback through machine learning techniques such as one or more reinforcement learning algorithms including but not limited to: Q-learning, SARSA, A3N, and DQN. Data received by the small business continuity planner serve as inputs to a machine learning algorithm. Recommendations are generated by the small business continuity planner, and the small business owner rates, or provides other feedback regarding the recommendations, which is stored by the small business continuity planner and serves as additional inputs to the machine learning algorithm to determine future recommendations. The small business continuity planner is configured to identify patterns in data and feedback to generate recommendations more likely to be implemented by the small business owner.

The small business continuity planner also implements learning classifiers which are trained based on feedback from the user to develop rules to define relationships between data. Rules associated with data are developed based on feedback from the user. For example, sales data at a restaurant may indicate higher volume of sales on the weekend, and the small business owner schedules more employees to work on the weekend, which leads the small business continuity planner to associate a rule that on days of the week with higher volume of sales on the weekend, more employees should be scheduled to work. In some examples, the small business continuity planner includes pre-trained classifiers and rules associated with data and data sources in addition to being configured to incorporate feedback from the user to further train the classifiers and further develop rules.

The second state of the small business continuity planner may execute actions with user approval. Some examples of the small business continuity planner may allow for a user to automatically approve the small business continuity planner's short-term and long-term solutions based on severity ratings. For example, the user may automatically approve the small business continuity planner to execute low severity rated actions such as to send notices to the employees of the business, but require user approval for higher severity rated actions such as buying more inventory.

Other examples of the small business continuity planner are configured to allow the user to set automatic approval of specific actions regardless of the severity ratings, or place other restrictions on the actions the small business continuity planner may execute. For example, the user may automatically approve sending notifications, but restrict sending notices before 7 AM and after 10 PM.

The second state of the small business continuity planner receives feedback from the user to integrate into future decision making as well. When the user is satisfied with the recommendations of the small business continuity planner, the user graduates the small business continuity planner from the second state to a third state with little to no user oversight.

The third state of the small business continuity planner operates autonomously, without needing user approval to implement most if not all long-term and short-term solutions. The user still has the option to veto actions, and modify the small business continuity planner's configuration. The third state of the small business continuity planner continues receiving feedback which is taken into account in future determinations.

### A Small Business Continuity Planner System

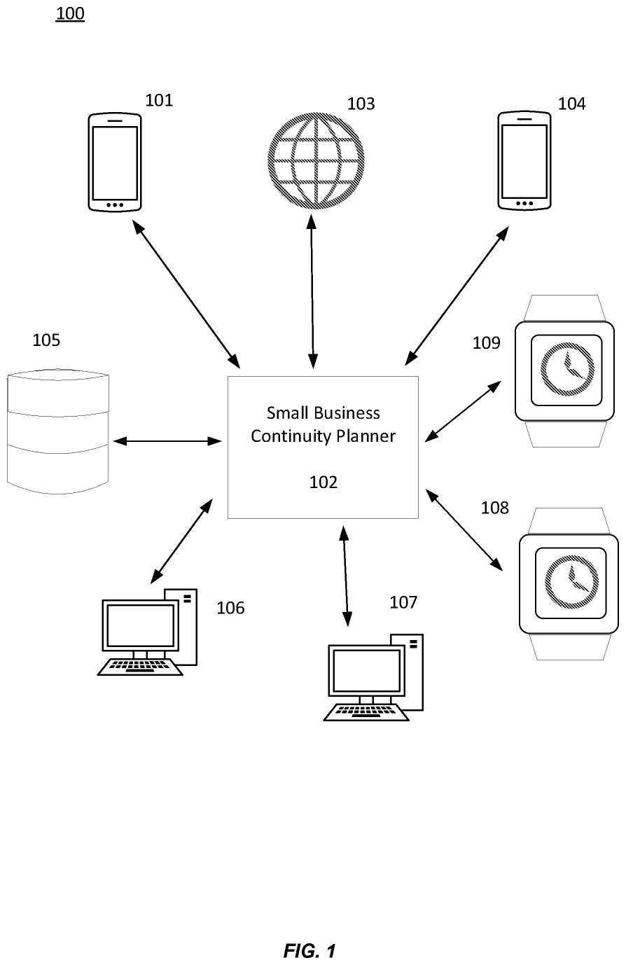

FIG. 1 shows an illustrative small business continuity planner system 100. The small business continuity planner system includes a small business continuity planner 102, multiple devices such as mobile devices 101, 104, wearable devices 108, 109 and computers 106, 107 connected to the small business continuity planner 102, and sources of current external data such as internet 103, which includes webpages, online videos, internet of things sensors, and other internet accessible information. The small business continuity planner 102 also receives information from sources of current external data such as a database 105, which includes databases of product information, historical sales data, historical traffic data, and other data.

In FIG. 1, the small business continuity planner 102 is configured to receive current local data and current external data to and from multiple sources. For example, device 101 represents a mobile device of a user, in this example a small business owner. The small business owner receives recommendations from the small business continuity planner on a computing device, e.g., a mobile computing device such as a smartphone or tablet.

The small business owner may also modify, reject, or accept recommendations from the small business continuity planner 102 through a graphical user interface (GUI) that is accessible through an application on the user's phone, computer, tablet, other computing device, or through a web browser. The GUI includes tabs indicating information such as lists of data sources, tabs indicating information input by the user, tabs indicating prior recommendations, and other tabs indicating other information. The GUI is configurable by the user, allowing the user to rearrange objects and to adjust settings. The GUI is also configured to allow users to input information and add data sources to the small business continuity planner through an input field or search for information through a search bar. For example, where a user would like for the small business continuity planner to monitor a particular webpage, such as a webpage for local school closures, the user inputs a Uniform Resource Locator (URL) associated with the webpage into the GUI through an input field. The small business continuity planner adds the input URL to a list of data sources that the small business continuity planner monitors.

The GUI also includes other elements such as a search bar that uses Natural Language Processing, a notifications icon indicating recommendations and other information, drop down menus, and other menus.

FIG. 1 demonstrates a small business continuity planner 102 that is configured to run independent of the small business owner's device. The small business continuity planner 102 may operate on a server system, such as in a cloud network. Alternative examples of the small business continuity planner 102 are configured to operate on a computing device local to the small business owner or other user, such as in an application on a phone, tablet, or computer.

Mobile device 104 is a mobile device associated with an employee of the small business owner. The mobile device 104 receives notifications from the small business continuity planner. The employee associated with the mobile device 104 however may not have authority to modify the recommendations of the continuity planner, unless the small business owner provides the authority to the employee.

The small business continuity planner 102 communicates with data sources on the internet 103 to monitor webpages for text and audio/visual sources. The small business continuity planner 102 monitors websites for current and prior external data including but not limited to information relevant to the business such as weather, supply chain delays, product manufacturing delays, holidays, local disruptions such as loss of power, gas pipe leaks, car wrecks, road maintenance, utility maintenance, fires, criminal activity, and local events such as political events and sports events.

The small business continuity planner 102 also communicates with databases 105. The databases 105 include current and prior local data and external data. Local data includes but is not limited to one or more of: current inventory, current staffing levels, employee availability, employee wages, business products, business services, historical sales data, geographic location of the business, and geographic location of competing businesses. The small continuity business planner 102 reads information from the database 105 and write to the database 105.

Further, the small business continuity planner 102 communicates to other computing devices such as computers 106, 107 and wearable devices 108, 109 such as a smart watch, smart glasses, or other wearable devices. The small business continuity planner is accessible through applications or through a browser on computers 106, 107.

### Illustrative Methods of Operation of a Small Business Continuity Planner System

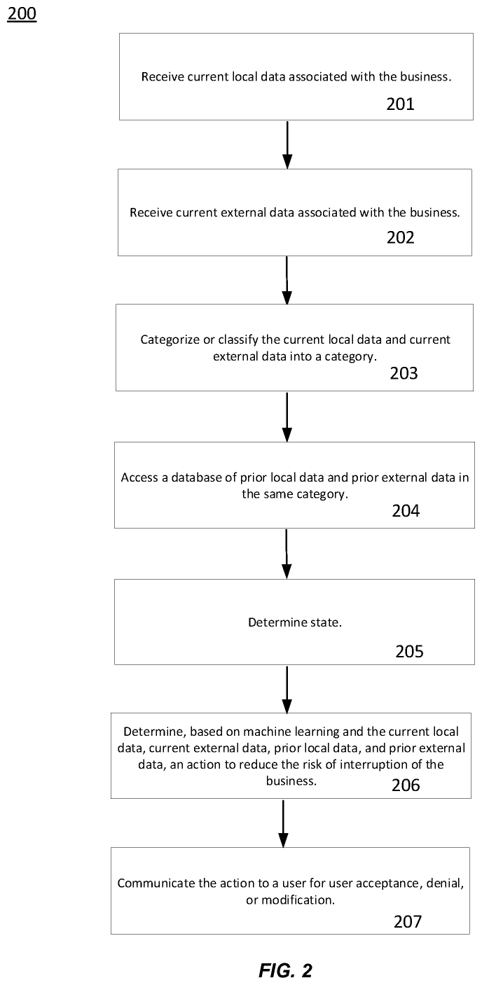

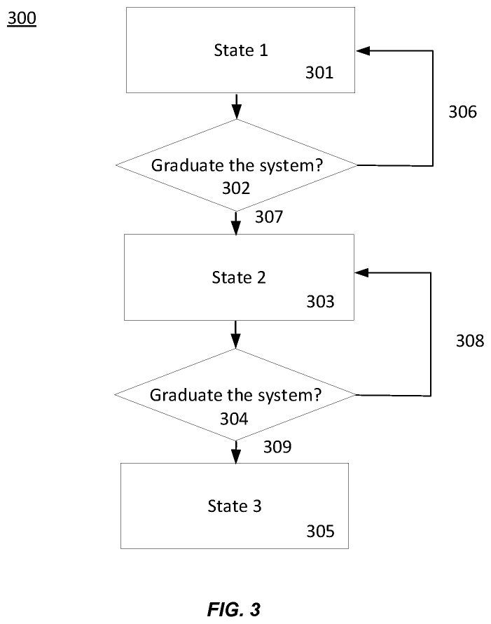

FIGS. 2 and 3 are flowcharts showing illustrative methods 200 and 300 for operation of a small business continuity planner system. In some examples, some of the steps in flow charts of FIGS. 2 and 3 are implemented in program code executed by a processor, for example, the processor in a general purpose computer, mobile device, or server. In some examples, these steps are implemented by a group of processors. In some examples the steps shown in FIGS. 2 and 3 are performed in a different order or one or more steps may be skipped. Alternatively, in some examples, additional steps not shown in FIGS. 2 and 3 may be performed.

The method 200 begins with step 201, when the small business continuity planner receives current local data associated with the business. The small business owner or other user enters data into the small business continuity planner, such as the location of the business, data associated with employees of the business, opening and closing time of the business, and other data. The small business owner may enter data associated with the business through a template, or questionnaire with input fields or selections for the small business owner. The small business continuity planner also receives data from applications used by the business. For example, the small business owner may use a bookkeeping application to track payroll, sales data, and other information. The small business continuity planner may receive current local data associated with the business from the bookkeeping application, such as payroll information, sales data, and other information.

Step 202 includes receiving current external data associated with the business. Steps 201 and 202 may be carried out concurrently or completed in a different order. The small business continuity planner uses agents to receive information from sources external to the business configured to establish and activate API calls; screen scrape information by extracting readable information from news sites or other websites; implementing Natural Language Processing (NLP) to extract information from websites through the websites' HTML code; process audio/visual sources; monitor emergency services; monitor weather services; and monitor other written, audio, and visual data sources. For example, when implemented in a business such as an ice cream parlor, the small business continuity planner may monitor a weather channel to identify expected temperatures throughout the week, monitor news sites to identify disruptions to dairy industries, and monitor websites from suppliers to identify recalls on products.

The method 200 continues with step 203 when the small business continuity planner categorize or classifies the current local data and current external data into a category. The small business continuity planner categorizes or classifies the local and current external data into categories based on a number of characteristics of the data including but not limited: a severity rating, velocity of the data, and subject matter such as employee data, weather related data, local disruptions, local events, scheduled disruptions such as holidays, maintenance, or other categories. Data is categorized by the small business continuity planner based on shared characteristics. In the example of the ice cream parlor, the small business continuity planner categorizes employees by what part of town they live in, by the employee hourly wage, by employee skillset, and other shared characteristics.

In step 204, the small business continuity planner accesses a database of prior local data and prior external data in the same category. For example, where the small business continuity planner is implemented in an ice cream parlor, the small business continuity planner accesses data such as prior employee absence history, historical sales data, historical temperature data, data related to the ice cream parlor's product, as well as other data.

The method continues to step 205, when the small business continuity planner determines the state of the small business continuity planner. The small business continuity planner is given different levels of authority to act by the user based on the state. FIG. 3 demonstrates transitions between the different levels of authority given to by the user to the small business continuity planner and is described in further detail in following paragraphs.

In step 206, the small business continuity planner determines based on machine learning and the current local data, current external data, prior local data and prior external data, an action to reduce the risk disruptions pose to interrupting business. The actions determined by the small business continuity planner may be short-term or long-term solutions to reduce risks posed by disruptions, or to fix a current or anticipated disruption to the business.

The small business continuity planner in step 207 then communicates the action to a user for user acceptance, denial, or modification. In some examples, the user receives a notification on the user's personal device that the small business continuity planner has determined an action to take regarding a disruption. The user views the action and notification on an application on their phone, browser, computer, or other computing device.

Alternative examples may include the small business continuity planner executing an action and then notifying the user. Further examples may add an additional step at the end, which includes the small business continuity planner executing an action based on the user's acceptance, denial, or modification.

The method 300 illustrates graduating the small business continuity planner between three states 301, 303, 305 in which the small business continuity planner has increasing authority to act without user approval. Feedback from the user may be implemented in determinations by the small business continuity planner in the three states 301, 303, 305.

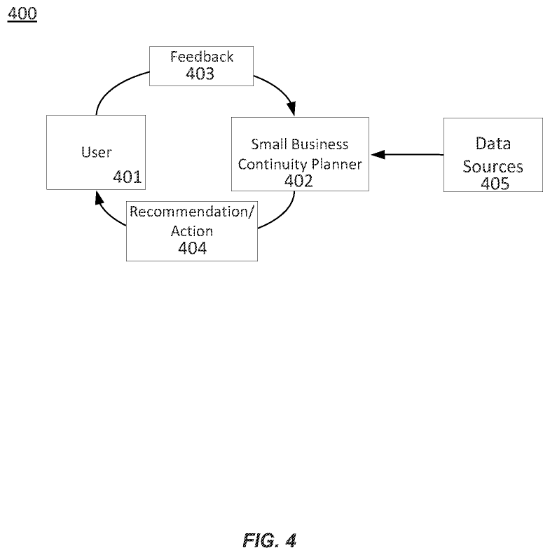

For example, state 1 301, is a state with no authority given by the user to the small business continuity planner to execute actions. In state 1 301, the small business continuity planner may carry out the steps illustrated in FIG. 2, however the system does not execute the actions determined by step 205. The user provides feedback to the small business continuity planner, which the small business continuity planner may implement in future determinations. The feedback may be an acceptance of the recommendation, a denial of the recommendation, or the user may modify the recommendation and accept the modified recommendation. For example, where the small business continuity planner is implemented in a grocery store, the small business owner may use the small business continuity planner to order inventory for the store. The store orders frozen vegetables when vegetables are out of season, and orders fresh when vegetables are in season. When the grocery store running low on fresh vegetables, the small business continuity planner may recommend purchasing more fresh vegetables. When the vegetables are in season, the small business owner accepts the recommendation and when vegetables are out of season and the small business owner prefers to purchase frozen vegetables, the small business owner modifies the small business continuity planner recommendation providing feedback to the small business continuity planner. Feedback may include rules set by the user. In the example of the grocery store, the small business owner may set a rule that no fresh vegetables are to be restocked after a set date. The small business continuity planner stores the rule and implements the rule with other underlying logic to determine future recommendations. FIG. 4 is a flowchart demonstrating the use of data and feedback from past recommendations received by the small business continuity planner in determining future recommendations. FIG. 4 is described in further detail in following paragraphs.

The user makes a determination of whether to graduate the small business continuity planner shown by 302 and 304. When the user's determination is to keep the small business continuity planner in the current state, the small business continuity planner will remain in the current state, as shown by 306 and 308. When the user's determination is to graduate the small business continuity planner, shown by 307 and 309, the small business continuity planner graduates to another state, and is given authority by the user to execute actions.

While the small business continuity planner is in state 2 303, the small business continuity planner executes actions with oversight from the user. The user may automatically approve executing user selected actions, but may require user permission before executing other actions.

While the small business continuity planner is in state 3 305, the small business continuity planner executes actions with little to no oversight from the user. The user may still accept, deny, or modify the small business continuity planner's actions, however in state 3, most if not all actions by the small business continuity planner are automatically approved by the user to be executed.

### Illustrative Example of Small Business Continuity Planner Feedback and Machine Learning

FIG. 4 is an exemplary flowchart demonstrating the use of data sources 405 and feedback 403 from recommendations and actions 404 received by the small business continuity planner 402 in determining future recommendations and actions. The small business continuity planner 402 provides a recommendation or action 404 to the user based on data received from data sources 405. The user 401 evaluates the recommendation or action, and provides feedback 403 to the small business continuity planner 402. The feedback 403 from user 401 may include rules from the user that the small business continuity planner 402 follows in determining future recommendations and actions.

In other examples, the small business continuity planner determines rules based on shared characteristics of feedback from the user, and shared characteristics of data. For example, where the small business continuity planner is being used to cover a shift from a sick employee, the small business continuity planner recommends replacing the sick employee's shift with an employee with shared characteristics such as comparable pay rates, skills, title, or other shared characteristics. Feedback from the user may add additional characteristics to the data. In the example of covering shifts of a sick employee, the small business continuity planner recommends an employee with a similar pay rate and availability, but the user may disagree because the employee lacks a skill necessary to cover the sick employee's shift. In future recommendations, the small business continuity planner identifies whether employees have similar skills when determining recommendations for covering shifts.

Data sources 405 include sources such as a shared database. The shared database may include feedback, other data, and data sources from other small business continuity planners which allows the small business continuity planners to learn from decisions made by other users.

### Illustrative Example of Communication between Small Business Continuity Planners

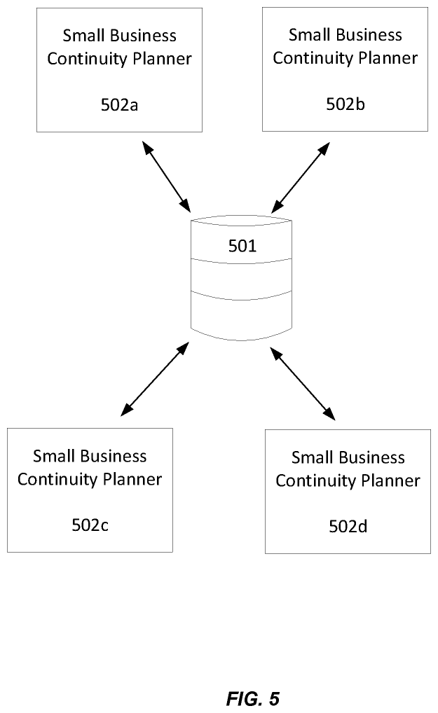

FIG. 5 shows the connection of multiple illustrative small business continuity planners 502a, 502b, 502c, and 502d. The small business continuity planners 502a-502d communicate with a shared database 501. The shared database 501 are configured to save configurations of individual small business continuity planners 502a-502d, and to share data and data sources with other small business continuity planners. This allows for small business continuity planners to learn from decisions made by other users. Alternative examples may include the small business continuity planners 502a-502d sharing data directly to each other instead of with a shared database 501.

### Example Advantages of a Small Business Continuity Planner

The small business continuity planner is useful for small businesses in preventing interruptions to business. For example, in one embodiment, if the small business continuity planner monitors a news feed and determines that there is a protest turning violent nearby, the small business continuity planner notifies the user. The small business continuity planner recommends sending employees home, locking the doors, or securing the windows. The small business continuity planner may additionally notify employees commuting to work about dangerous conditions and advise the employees to return home. The small business continuity planner may notify the user that it recommends the user board the business's windows, and may order boards from a local hardware store if the user has granted authority.

Other examples may include the small business continuity planner monitoring weather. For example, the small business continuity planner monitors a weather service, and when the small business continuity planner detects a weather event such as a tornado or hurricane in the area, the small business continuity planner may notify the employees about the weather event, and recommend the employees seek shelter. Other recommendations may include ordering materials to protect the business.

Other disruptions to business may be anticipated by the small business continuity planner such as anticipating an employee running late. The small business continuity planner may receive location information from an employee's phone and determine based on traffic data, the employee's scheduled shift, and the employee's estimated time of arrival, that an employee will be late to work. As a short-term solution, the small business continuity planner may notify the small business owner or other employees about the employee running late, and the small business continuity planner may provide updates regarding the employee's commute to work. Long-term solutions might be to recommend sending the employee scheduled notifications of upcoming shifts, or scheduling the employee for later shifts.

Further examples include anticipating that an employee is likely to not show up for work. For example, the small business continuity planner may receive information regarding a flood or other natural disaster affecting a part of town. The small business continuity planner determines that employees residing in the affected part of town are likely unable to make it to work. The small business continuity planner may contact the small business owner to replace the shifts of affected employees with other employees.

The small business continuity planner also anticipates supply chain risks and issues with inventory such as scarcity of materials and recalls to products. The small business continuity planner monitors news sites and receive information regarding shortage of materials relevant to a business. The small business continuity planner recommends the small business owner order more of the materials to prevent the small business from running out of supply if the material becomes scarce, or may recommend alternative vendors.

In other examples, the small business continuity planner may anticipate that an employee will be late for work. For example the small business continuity planner may receive information regarding the location of an employee scheduled to open a small business in the morning. The small business continuity planner may determine that the employee will be late, and thus opening will be delayed, based on, for example, location data and conditions at those locations, such as the location of the employee, location of the business, and traffic conditions. Based on this determination, the small business continuity planner may notify the small business owner, or another employee who is able to open the business, so that they can open the business instead. In another embodiment, the small business continuity planner may recommend actions to enable the business to open in the event of disruption, e.g., cutting additional copies of the keys for other employees or scheduling employees who live closer to the business to prevent future disruptions to opening the business.

In another example, the small business continuity planner may identify patterns in employees requesting time off from work or using sick leave. For example, the small business continuity planner may identify that a specific employee always requests time off to visit family for a holiday or that an employee regularly calls in sick during or after major sporting events such as football games. Based on this information, in some embodiments, the small business continuity planner may determine that an employee is likely to request time off for certain days, and may recommend work schedules that take into account likely absences and requests for time off. The small business continuity planner may also recommend coaching sessions for employees who regularly call in sick during or after major sporting events. In still other embodiments, the small business continuity planner may monitor public social media posts to identify whether the employee attended the major sporting event while calling in sick and provide documentation of the public social media posts to the small business owner.

Although the subject matter has been described in language specific to structural features or methodological acts, it is to be understood that the subject matter of the appended claims is not necessarily limited to the specific features or acts described above. Rather, the specific features and acts described above are disclosed as examples.

Various operations of examples are provided herein. The order in which one or more or all of the operations are described should not be construed as to imply that these operations are necessarily order dependent. Alternative ordering will be appreciated based on this description. Further, not all operations may necessarily be present in each example provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has,” “with,” or variants thereof are used in either the detailed description or the claims, such terms are intended to be inclusive in a manner similar to the term “comprising”.

Further, unless specified otherwise, “first,” “second,” or the like are not intended to imply a temporal aspect, a spatial aspect, or an ordering. Rather, such terms are merely used as identifiers, names, for features, elements, or items. For example, a first state and a second state generally correspond to state 1 and state 2 or two different or two identical states or the same state. Additionally, “comprising,” “comprises,” “including,” “includes,” or the like generally means comprising or including.

Although the disclosure has been shown and described with respect to one or more implementations, equivalent alterations and modifications will occur based on a reading and understanding of this specification and the drawings. The disclosure includes all such modifications and alterations and is limited only by the scope of the following claims.

1. A method comprising:
receiving current local data associated with a business;
receiving from an agent current external data associated with the business, wherein the agent is configured to enter a dormant state when a velocity of the external data falls below a threshold;
categorizing the current local data and current external data into a category;
accessing a database of prior local data and prior external data in the same category;
determining, based on machine learning and the current local data, current external data, prior local data, and prior external data, and a velocity of the current local data, current external data, prior local data, and prior external data, an action to reduce a risk of interruption of the business; and
communicating the action to a user, and the user may accept, reject, or modify the action.

2. The method of claim 1, wherein the local data comprises one or more of:
current inventory, current staffing levels, employee availability, employee wages, business products, business services, historical sales data, geographic location of the business, and geographic location of competing businesses.

3. The method of claim 1, wherein the external data comprises information associated with one or more of: weather, supply chain delays, product manufacturing delays, holidays, loss of power, gas pipe leaks, car wrecks, road maintenance, utility maintenance, fires, criminal activity, political events, and sports events.

4. The method of claim 1, wherein the action comprises one or more of: ordering additional inventory, scheduling additional employee shifts, or ordering additional business hardware.

5. The method of claim 1, wherein determining an action to reduce the risk of interruption of the business further comprises determining that there is a likelihood of a natural disaster and determining the action to maintain business operations during the natural disaster.

6. The method of claim 5, wherein the action comprises ordering additional inventory that is likely to be in short supply during the natural disaster.

7. (canceled)

8. The method of claim 1, wherein the machine learning stores whether the user accepted, rejected, or modified the action and uses that information in determining future actions.

9. (canceled)

10. The method of claim 1, wherein the method is implemented by a software package comprising a pre-configured template designed to manage a category of business.

11. A non-transitory computer readable medium comprising instructions that when executed by one or more processors cause the one or more processors to:
receive current local data associated with a business;
receive from an agent current external data associated with the business, wherein the agent is configured to enter a dormant state when a velocity of the external data falls below a threshold;
categorize the current local data and current external data into a category;
access a database of prior local data and prior external data in the same category;
determine, based on machine learning and the current local data, current external data, prior local data, and prior external data, and a velocity of the current local data, current external data, prior local data, and prior external data an action to reduce a risk of interruption of the business; and
communicate the action to a user, and the user may accept, reject, or modify the action.

12. The non-transitory computer readable medium of claim 11, wherein the local data comprises one or more of: current inventory, current staffing levels, employee availability, employee wages, business products, business services, historical sales data, geographic location of the business, and geographic location of competing businesses.

13. The non-transitory computer readable medium of claim 11, wherein the external data comprises information associated with one or more of: weather, supply chain delays, product manufacturing delays, holidays, local disruptions such as loss of power, gas pipe leaks, car wrecks, road maintenance, utility maintenance, fires, criminal activity and local events such as political events and sports events.

14. The non-transitory computer readable medium of claim 11, wherein the action comprises one or more of: ordering additional inventory, scheduling additional employee shifts, or ordering additional business hardware.

15. The non-transitory computer readable medium of claim 11, wherein determining an action to reduce the risk of interruption of the business further comprises determining that there is a likelihood of a natural disaster and determining the action to maintain business operations during the natural disaster.

16. The non-transitory computer readable medium of claim 15, wherein the action comprises ordering additional inventory that is likely to be in short supply during the natural disaster.

17. (canceled)

18. The non-transitory computer readable medium of claim 11, wherein the machine learning stores whether the user accepted, rejected, or modified the action and uses that information in determining future actions.

19. (canceled)

20. A system comprising:
one or more processors; and
a memory that stores instructions that, when, executed by the one or more processors, cause the one or more processors to:
receive current local data associated with a business;
receive from an agent current external data associated with the business, wherein the agent is configured to enter a dormant state when a velocity of the external data falls below a threshold;
categorize the current local data and current external data into a category;
access a database of prior local data and prior external data in the same category;
determine, based on machine learning and the current local data, current external data, prior local data, and prior external data, and a velocity of the current local data, current external data, prior local data, and prior external data, an action to reduce a risk of interruption of the business; and
communicating the action to a user, and the user may accept reject, or modify the action.
